(19) United States
(12) Patent Application Publication
(10) Pub. No.: US 2014/0028591 A1
(43) Pub. Date: Jan. 30, 2014

(54) PANEL CONTROL DEVICE, PANEL CONTROL METHOD, AND NON-TRANSITORY COMPUTER-READABLE MEDIUM

(71) Applicant: BROTHER KOGYO KABUSHIKI KAISHA, Nagoya-shi (JP)

(72) Inventors: Mitsuhiro KANDA, Nagoya-shi (JP); Junya KAWAI, Nagoya-shi (JP)

(21) Appl. No.: 13/944,015

(22) Filed: Jul. 17, 2013

(30) Foreign Application Priority Data
Jul. 25, 2012 (JP) 2012-164411

(51) Int. Cl. G06F 3/041

(52) U.S. Cl. CPC G06F 3/0416
USPC 345/173

(57) ABSTRACT

A panel control device includes a processor. The processor is configured to perform processes including acquiring a plurality of pressed positions, each of the plurality of pressed positions being a pressed position identified at each of a plurality of timings within a continuous time period, the continuous time period being a time period determined based on an operation time period in which a panel surface is pressed, and the pressed position being a position at which a pressing force is applied to the panel surface, identifying a tendency of change of the pressed positions based on the plurality of pressed positions, and determining each of the plurality of pressed positions as a specified position in a case where the identified tendency of change satisfies a predetermined condition, the specified position being a pressed position, on the panel surface, that is specified by a user.

### CROSS-REFERENCE TO RELATED APPLICATION

This application claims priority to Japanese Patent Application No. 2012-164411, filed Jul. 25, 2012, the content of which is hereby incorporated herein by reference in its entirety.

### BACKGROUND

The present disclosure relates to a panel control device, a panel control method and a non-transitory computer-readable medium that control a touch panel on which writing is performed by pressing a panel surface using a stylus or a finger etc.

A touch panel is known on which writing is performed by a user pressing a panel surface using a stylus, a finger or the like (hereinafter referred to as an “input portion”). In this type of touch panel, in the course of writing using the input portion, there are cases in which the panel surface is pressed by an object other than the input portion, such as a part of a hand, a palm of the hand or a joint of a finger, an arm, a wrist watch, clothes or the like, for example. In this type of case, in order to identify information written using the input portion, it is necessary to distinguish a region that is pressed by the input portion from a region that is pressed by an object other than the input portion.

Technology has been disclosed, for example, in which a region that is pressed by the input portion is distinguished from a region that is pressed by a palm of a hand, depending on an area of the pressed region. In this technology, when the area of the pressed region is small, it is determined that the region has been pressed by the input portion. On the other hand, when the area of the pressed regions is large, it is determined that the region has been pressed by the palm of the hand.

### SUMMARY

The area of the region pressed by the object other than the input portion is not necessarily always larger than the area of the region pressed by the input portion. Therefore, even in a case in which the above-described technology is adopted, there are cases in which the region pressed by the input portion cannot be clearly distinguished from the region pressed by the object other than the input portion.

Embodiments of the broad principles derived herein provide a panel control device, a panel control method and a non-transitory computer-readable medium that are capable of distinguishing between a region that is pressed by an input portion and a region that is pressed by an object other than the input portion.

Various embodiments provide a panel control device includes a processor. The processor is configured to perform processes including acquiring a plurality of pressed positions, each of the plurality of pressed positions being a pressed position identified at each of a plurality of timings within a continuous time period, the continuous time period being a time period determined based on an operation time period in which a panel surface is pressed, and the pressed position being a position at which a pressing force is applied to the panel surface, identifying a tendency of change of the pressed positions based on the plurality of pressed positions, and determining each of the plurality of pressed positions as a specified position in a case where the identified tendency of change satisfies a predetermined condition, the specified position being a pressed position, on the panel surface, that is specified by a user.

Embodiments also provide a panel control method includes acquiring a plurality of pressed positions, each of the plurality of pressed positions being a pressed position identified at each of a plurality of timings within a continuous time period, the continuous time period being a time period determined based on an operation time period in which a panel surface is pressed, and the pressed position being a position at which a pressing force is applied to the panel surface, identifying, based on the acquired plurality of pressed positions, a tendency of change of the pressed positions, and determining each of the plurality of pressed positions as a specified position in a case where the identified tendency of change satisfies a predetermined condition, the specified position being a pressed position, on the panel surface, that is specified by a user.

Embodiments further provide a non-transitory computer-readable medium storing computer-readable instructions that cause a panel control device to perform the steps of acquiring a plurality of pressed positions, each of the plurality of pressed positions being a pressed position identified at each of a plurality of timings within a continuous time period, the continuous time period being a time period determined based on an operation time period in which a panel surface is pressed, and the pressed position being a position at which a pressing force is applied to the panel surface, identifying, based on the acquired plurality of pressed positions, a tendency of change of the pressed positions, and determining each of the plurality of pressed positions as a specified position in a case where the identified tendency of change satisfies a predetermined condition, the specified position being a pressed position, on the panel surface, that is specified by a user.

### BRIEF DESCRIPTION OF THE DRAWINGS

Embodiments will be described below in detail with reference to the accompanying drawings in which:

FIG. 1 is a diagram showing a hand writing input system;

FIG. 2 is a block diagram showing an electrical configuration of a PC and an electronic writing device;

FIG. 3 is a diagram showing a conductive sheet;

FIG. 4 is a cross-sectional view taken along a line IV-IV shown in FIG. 3, when viewed from an arrow direction;

FIG. 5 is a diagram showing a table;

FIG. 6 is a flowchart of main processing;

FIG. 7 is a diagram showing a table;

FIG. 8 is a flowchart of identification processing according to a first example;

FIG. 9 is a flowchart of identification processing according to a second example;

FIG. 10 is a flowchart of identification processing according to a third example; and

FIG. 11 is a flowchart of identification processing according to a fourth example.

### DETAILED DESCRIPTION

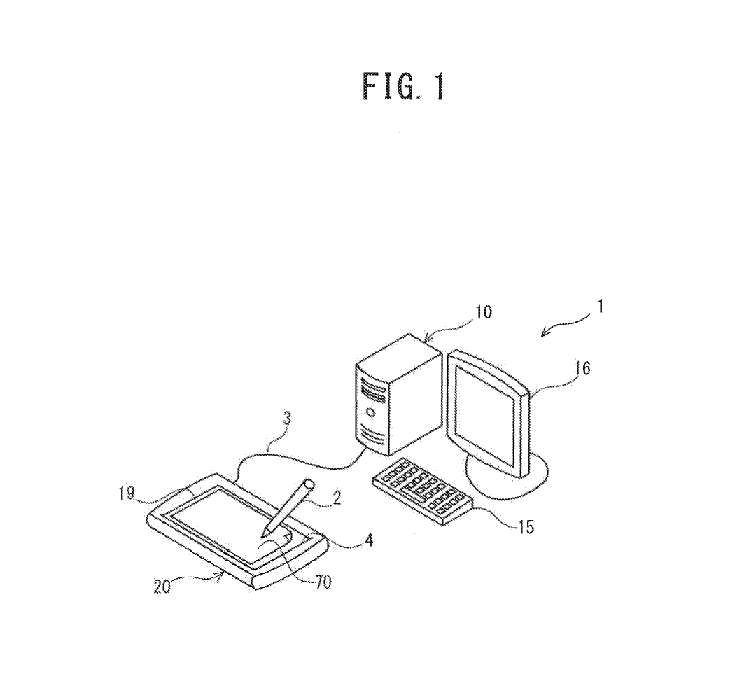

Hereinafter, an embodiment of the present disclosure will be explained with reference to the drawings. A hand writing input system 1 will be explained with reference to FIG. 1. The hand writing input system 1 is a system to identify and computerize handwriting when writing is performed using a general purpose writing tool 2, and to store the computerized handwriting as handwriting data. The hand writing input system 1 includes a PC 10 and an electronic writing device 20. The PC 10 and the electronic writing device 20 are connected via a communication cable 3.

The electronic writing device 20 includes a recessed placement portion 4 on a top surface. A touch panel 19 is provided on a bottom surface of the placement portion 4. A shape of the touch panel 19 is substantially rectangular. A resistive film method may be used to drive the touch panel 19. When the touch panel 19 is pressed by the tip end of the writing tool 2 in accordance with a writing operation performed using the writing tool 2, a position of an applied pressing force is identified. Hereinafter, the position of the applied pressing force is referred to as a pressed position. The identified pressed position is transmitted from the electronic writing device 20 to the PC 10 via the communication cable 3.

For example, a user places a paper medium 70 on the touch panel 19 of the electronic writing device 20. The user may use the writing tool 2 (a ballpoint pen, a mechanical pencil or the like) to perform writing on the paper medium 70. Lines are drawn on the paper medium 70. At the same time, a pressing force is applied to the touch panel 19 by the writing operation performed using the writing tool 2. The pressed position is transmitted from the electronic writing device 20 to the PC 10. Based on the pressed position received from the electronic writing device 20, the PC 10 identifies handwriting. The identified handwriting is output on an output portion (a display) 16 of the PC 10. At the same time that the lines are drawn on the paper medium 70 using the writing tool 2, it is possible to verify, via the output portion 16, the handwriting obtained using the writing tool 2.

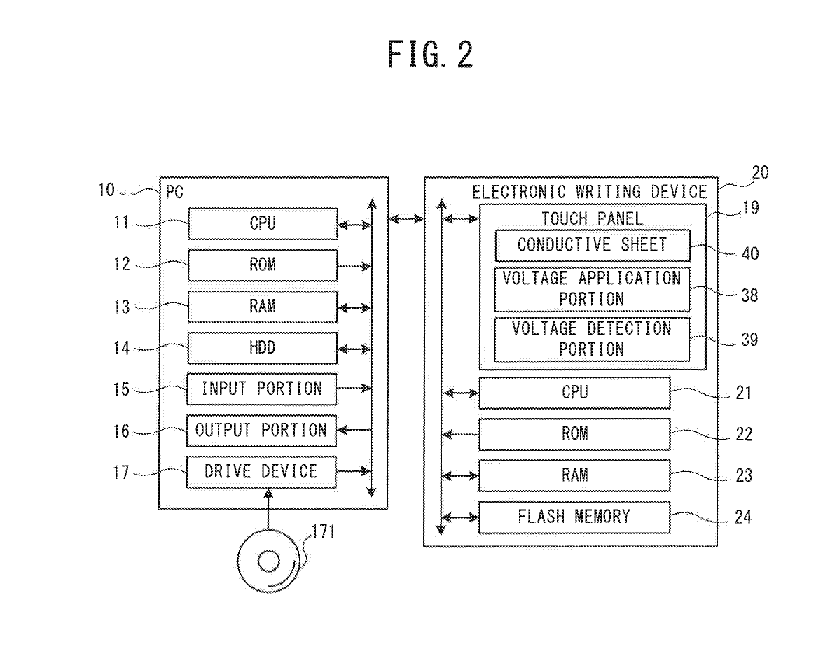

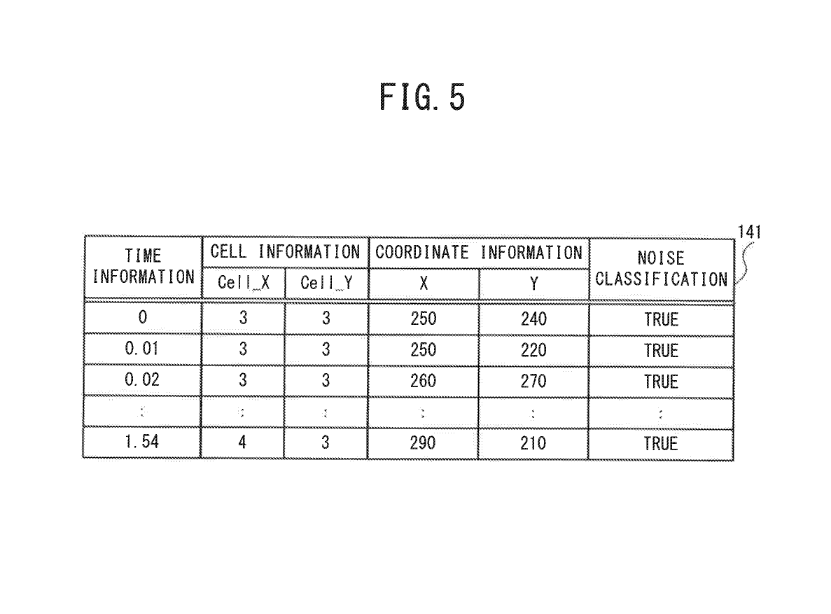

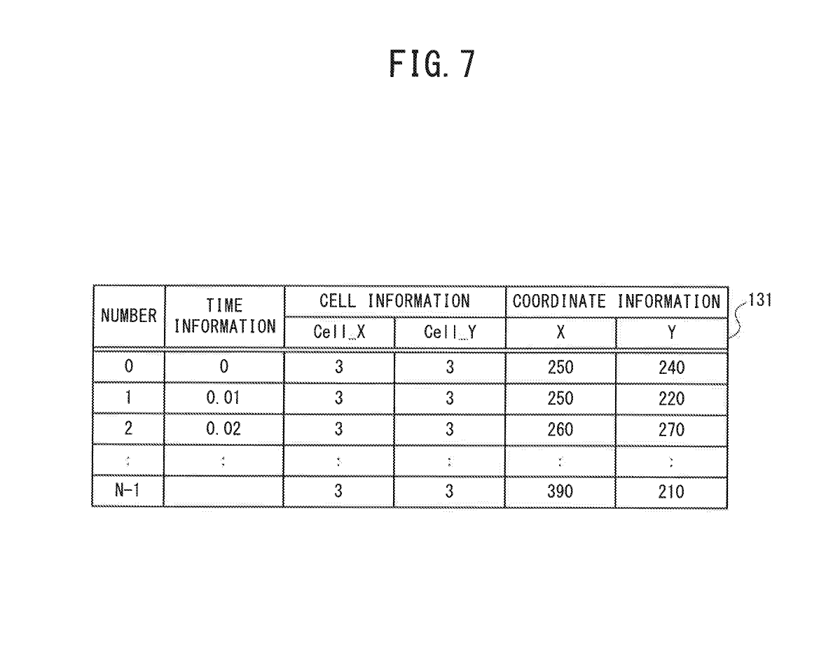

An electrical configuration of the PC 10 and of the electronic writing device 20 will be explained with reference to FIG. 2. The PC 10 includes a CPU 11, a ROM 12, a RAM 13, a hard disk drive (hereinafter referred to as “HDD”) 14, an input portion 15, the output portion 16 and a drive device 17. The CPU 11 performs overall control of the PC 10. A boot program, an OS and initial data are stored in the ROM 12. Temporary data and a table 131 (refer to FIG. 7) that will be described later are stored in the RAM 13. A program of the CPU 11 and a table 141 that will be described later (refer to FIG. 5) are stored in the HDD 14. The input portion 15 is, for example, a keyboard or a mouse that receives an operation with respect to the PC 10. The output portion 16 may be a display that outputs an image. The drive device 17 may read out information stored in a storage medium 171. For example, a program that is stored in the storage medium 171 is read out by the drive device 17 and is stored in the HDD 14. The CPU 11 performs processing based on the program stored in the HDD 14.

The program stored in the HDD 14 may be acquired via a network that is connected to a communication driver that is not shown in the drawings. The CPU 11 may store the program received via the network in the HDD 14.

The electronic writing device 20 includes a CPU 21, a ROM 22, a RAM 23, a flash memory 24 and the touch panel 19. The CPU 21 performs overall control of the electronic writing device 20. A boot program and initial data are stored in the ROM 22. Temporary data is stored in the RAM 23. A program of the CPU 21 is stored in the flash memory 24. The touch panel 19 includes a conductive sheet 40, a voltage application portion 38 and a voltage detection portion 39.

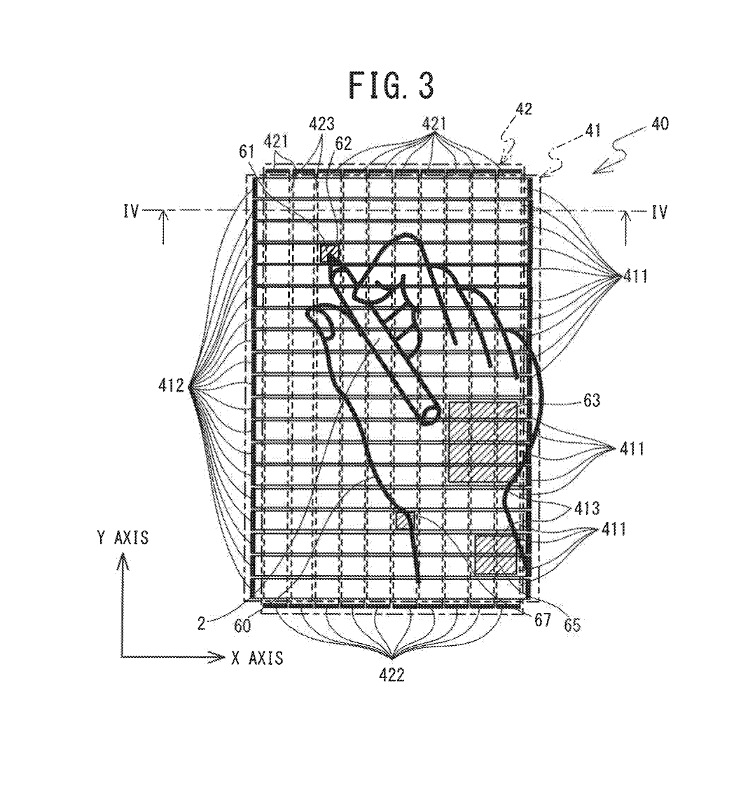

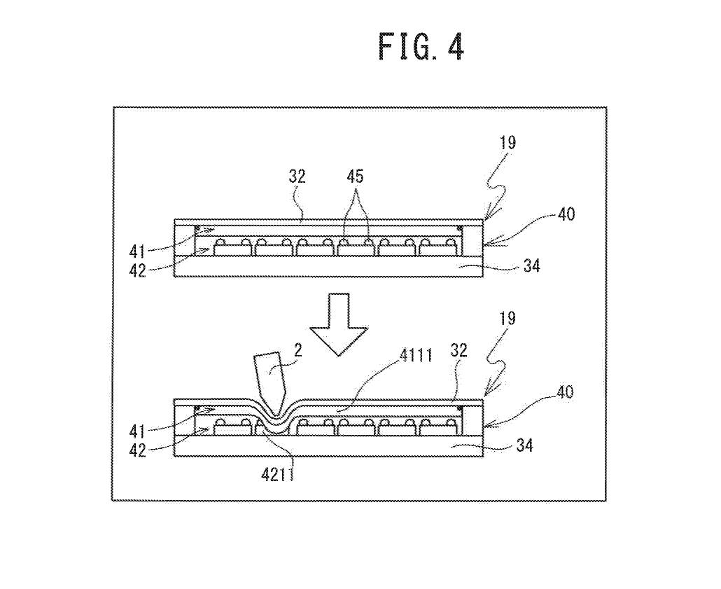

A configuration of the conductive sheet 40 will be explained with reference to FIG. 3. The conductive sheet 40 includes a first conductive film 41 and a second conductive film 42. The first conductive film 41 and the second conductive film 42 each have a substantially rectangular shape. The shape of the first conductive film 41 and the second conductive film 42 is substantially the same as the shape of the touch panel 19 (refer to FIG. 1). The first conductive film 41 and the second conductive film 42 are laminated. The first conductive film 41 is disposed on the top surface of the touch panel 19 with respect to the second conductive film 42. A plurality of spacers 45 (refer to FIG. 4) are provided between the first conductive film 41 and the second conductive film 42. The spacers 45 separate the first conductive film 41 from the second conductive film 42.

The first conductive film 41 includes a plurality of resistive films 411. Each of the resistive films 411 is transparent. Each of the resistive films 411 has a substantially rectangular shape, and a length in the longitudinal direction of each of the resistive films 411 is the same as a length in the lateral direction of the first conductive film 41. A length in the lateral direction of each of the resistive films 411 is shorter than a length in the longitudinal direction of the first conductive film 41 and sufficiently larger than a diameter of the tip end of the writing tool 2 (refer to FIG. 1). The resistive films 411 are arranged parallel to each other in the longitudinal direction of the first conductive film 41. Gaps 413 are provided in boundary portions between the resistive films 411 that are adjacent to each other. A distance between the gaps 413 is significantly shorter than the length in the lateral direction of the resistive films 411. Hereinafter, a direction in which the resistive films 411 are arranged (an up-down direction in FIG. 3) is referred to as a Y-axis direction. A direction that is orthogonal to the Y-axis direction (a left-right direction in FIG. 3) is referred to as an X-axis direction. The Y-axis direction corresponds to the longitudinal direction of the first conductive film 41 and to the lateral direction of the resistive films 411. The X-axis direction corresponds to the lateral direction of the first conductive film 41 and to the longitudinal direction of the resistive films 411. Electrodes 412 are provided at both ends, in the X axis direction, of each of the resistive films 411. The voltage application portion 38 and the voltage detection portion 39 (refer to FIG. 2) are connected to the electrodes 412. The voltage application portion 38 may apply voltage to the resistive films 411 via the electrodes 412. The voltage detection portion 39 may detect voltage between the electrodes 412.

The second conductive film 42 includes a plurality of resistive films 421. Each of the resistive films 42 is transparent. The resistive films 421 have a substantially rectangular shape, and a length in the longitudinal direction of the resistive films 421 is the same as a length in the longitudinal direction of the second conductive film 42. A length in the lateral direction of the resistive films 421 is shorter than a length in the lateral direction of the second conductive film 42 and sufficiently larger than the diameter of the tip end of the writing tool 2. The Y-axis direction corresponds to the longitudinal direction of the second conductive film 42 and the resistive films 421. The X-axis direction corresponds to the lateral direction of the second conductive film 42 and the resistive films 421. The resistive films 421 are arranged in the lateral direction of the second conductive film 42, namely, in the X-axis direction. Gaps 423 are provided in boundary portions between the resistive films 421 that are adjacent to each other. A distance between the gaps 423 is significantly shorter than the length in the lateral direction of the resistive films 421. Electrodes 422 are provided at both ends, in the Y axis direction, of each of the resistive films 421. The voltage application portion 38 and the voltage detection portion 39 (refer to FIG. 2) are connected to the electrodes 422. The voltage application portion 38 may apply voltage to the resistive films 421 via the electrodes 422. The voltage detection portion 39 may detect voltage between the electrodes 422.

A state when a pressing force is applied to the touch panel 19 will be explained with reference to FIG. 4. Hereinafter, the upper side and the lower side of FIG. 4 respectively correspond to the upper side and the lower side of the touch panel 19. A film 32 is laminated on a surface of the first conductive film 41 of the conductive sheet 40, the surface being opposite to another surface of the first conductive film 41 that is close to the second conductive film 42. The film 32 protects the conductive sheet 40. The plurality of spacers 45 are provided between the first conductive film 41 and the second conductive film 42. The spacers 45 separate the first conductive film 41 from the second conductive film 42. A glass substrate 34 is laminated on a surface of the second conductive film 42, the surface being opposite to another surface of the second conductive film 42 that is close to the first conductive film 41. The glass substrate 34 supports the conductive sheet 40.

An example will be explained in which the paper medium 70 (refer to FIG. 1) is placed on the placement portion 4 (refer to FIG. 1) of the electronic writing device 20, and writing is performed on the paper medium 70 using the writing tool 2. A pressing force is applied, by the tip end of the writing tool 2, to the touch panel 19 that is provided on the bottom surface of the placement portion 4. The touch panel 19 deforms due to the pressing force applied by the writing tool 2. More specifically, the deformation occurs in the following manner. A downward pressing force is applied to the conductive sheet 40 from the film 32 side. The film 32 and the first conductive film 41 are deflected downward. A resistive film 4111 of the first conductive film 41 comes into contact with a resistive film 4211 of the second conductive film 42.

A method will be explained by which the CPU 21 (refer to FIG. 2) of the electronic writing device 20 detects a position to which a pressing force is applied. The voltage application portion 38 (refer to FIG. 2) applies a voltage between the electrodes 412 (refer to FIG. 3) and the electrodes 422 (refer to FIG. 3). The electrodes 412 are provided on the resistive films 411 (refer to FIG. 3) included in the first conductive film 41. The electrodes 422 are provided on the resistive films 421 (refer to FIG. 3) included in the second conductive film 42. As a result of the resistive film 4111 of the first conductive film 41 coming into contact with the resistive film 4211 of the second conductive film 42, the voltage between the electrodes 412 provided on the resistive film 4111 and the voltage between the electrodes 422 provided on the resistive film 4211 change. The voltage detection portion 39 connected to the electrodes 412 and 422 detects a voltage between the electrodes. The CPU 21 acquires the voltage detected by the voltage detection portion 39 and detects a voltage change between the electrodes 412 and 422. The CPU 21 identifies, as coordinate information, the position to which the pressing force has been applied in a region in which the resistive film 4111 provided with the electrodes 412 whose voltage has changed intersects with the resistive film 4211 provided with the electrodes 422 whose voltage has changed. Hereinafter, in the region in which the resistive film 4111 and the resistive file 4211 intersect, the position to which the pressing force has been applied is referred to as the pressed position. The CPU 21 as described above identifies the pressed position to which the pressing force is applied by the contact of an object, such as the writing tool 2, for each of cells in which the resistive films 4111 and 4211 intersect with each other, as coordinate information indicating the pressed position in each of the cells. The cell is the region in which the resistive films 4111 and 4211 intersect with each other.

The electronic writing device 20 periodically identifies, at a predetermined time interval, cell information and coordinate information. The cell information is information indicating a position of a pressed cell. The pressed cell is the cell that includes the pressed position. The predetermined time interval is, for example, 10 ms. The electronic writing device 20 transmits the cell information and the coordinate information to the PC 10. When the pressing force has not been applied to the touch panel 19, the electronic writing device 20 does not transmit the cell information and the coordinate information to the PC 10. When the PC 10 receives the cell information and the coordinate information from the electronic writing device 20, the PC 10 stores the received cell information and coordinate information in the table 141.

FIG. 5 shows an example of the table 141. Time information, the cell information, the coordinate information and noise classification, which are associated with each other, are stored in the table 141. The time information is information indicating a time at which the cell information and the coordinate information are received. Information indicating the position of the pressed cell in an X direction and a Y direction (Cell_X, Cell_Y) is stored as the cell information. An upper left cell shown in FIG. 3 is, for example, a reference for the cell information (a reference cell). Coordinate information (X, Y) inside the cell is stored as the coordinate information. A point at the bottom left of each of the cells shown in FIG. 3 is taken as a reference for the coordinate information. The coordinate information indicates a position of a certain point inside the one cell. The coordinate information indicates the position in the horizontal direction (X direction) and the vertical direction (Y direction) when the bottom left coordinates of the cell are taken as the reference (X, Y=0, 0).

In the table 141, for example, cell information received from the electronic writing device 20 at a timing indicated by time information 0 (s) is (Cell_X, Cell_Y=3, 3). In FIG. 3, the cell information (Cell_X, Cell_Y=3, 3) indicates a pressed cell 61 that is separated by three cells in the X direction and three cells in the Y direction from the upper left reference cell. Further, coordinate information (X, Y=250, 240) is associated with the cell information (Cell_X, Cell_Y=3, 3) that is associated with the time information 0 (s). The coordinate information (X, Y=250, 240) indicates a pressed position 62 within the region of the pressed cell 61. The pressed position 62 is the position pressed by the writing tool 2 inside the pressed cell 61.

An example in which a user uses the writing tool 2 (refer to FIG. 1) to perform a writing operation on the touch panel 19 (refer to FIG. 1) will be explained. As shown in FIG. 3, the user performs the writing operation using the writing tool 2 while stabilizing a hand 60 by placing the palm of the hand 60 or the wrist on the touch panel 19. In this case, in the course of the writing operation, there is a case in which a wrist watch or an accessory worn around the wrist is pressed against the touch panel 19. In this type of case, it is necessary for the CPU 11 of the PC 10 to distinguish and identify the pressed cell 61 to which the pressing force is applied by the tip end of the writing tool 2, and pressed cells 63, 65 and 67 to which a pressing force is applied by the palm of the hand 60 and the wrist. In the present embodiment, based on a change tendency of the coordinate information over time, the CPU 11 of the PC 10 identifies the pressed position on the touch panel 19 that is specified by the user using the writing tool 2 by executing processing that is explained below.

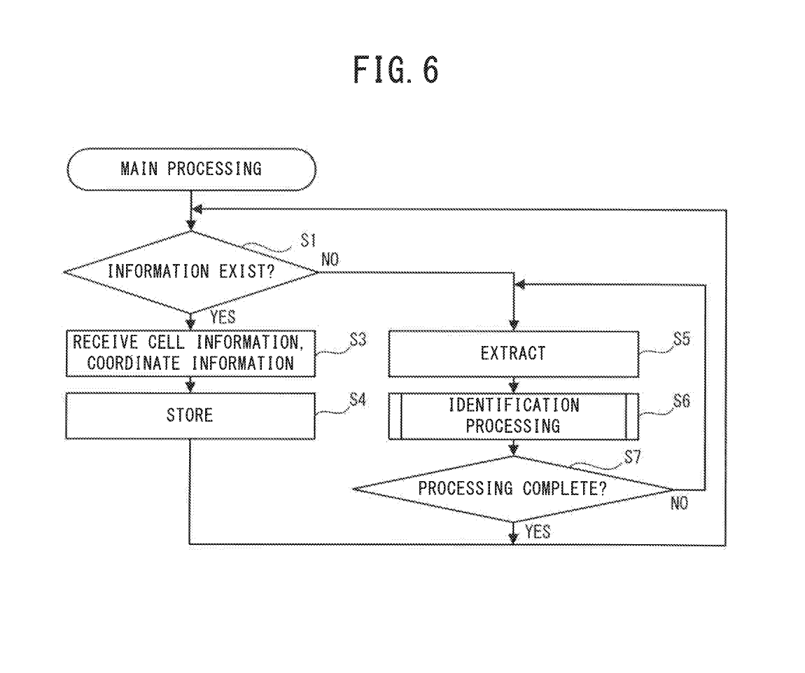

Processing executed by the CPU 11 will be explained with reference to FIG. 6 to FIG. 8. When a power supply of the PC 10 is turned on, main processing (refer to FIG. 6) is started by the CPU 11 executing the program stored in the HDD 14. When the pressing force is applied to the touch panel 19, the electronic writing device 20 periodically transmits the cell information and the coordinate information to the PC 10 at an interval of a predetermined time T. When the pressing force is not applied to the touch panel 19, the electronic writing device 20 does not transmit the cell information and the coordinate information to the PC 10.

The CPU 11 determines whether there is cell information and coordinate information which is periodically transmitted from the electronic writing device 20 (step S1). In a case where cell information and coordinate information is exist (yes at step S1), the CPU 11 receives the cell information and the coordinate information (step S3). The CPU 11 stores the received cell information and coordinate information in the table 141 in association with time information (step S4). The time information indicates the time at which the cell information and the coordinate information are received. The processing returns to step S1.

The CPU 11 stores the received cell information and coordinate information in the table 141 in association with the time information in the following manner. When the CPU 11, which is in a state of not periodically receiving the cell information and the coordinate information, receives the cell information and the coordinate information, the CPU 11 associates the received cell information and coordinate information with the time information 0 and stores the associated information in the table 141. The state in which the CPU 11 does not periodically receive the cell information and the coordinate information is a state in which the CPU 11 does not continuously receive the cell information and the coordinate information from the electronic writing device 20 for a period of time that is longer than the predetermined time T. During a period in which the CPU 11 periodically receives the cell information and the coordinate information, the CPU 11 adds the time information by adding the predetermined time T each time and updates the table 141 accordingly. The CPU 11 associates the received cell information and coordinate information with the time information and stores the associated information in the table 141. In the present embodiment, as shown in the table 141 in FIG. 5, the time information is added and updated by adding the predetermined time T (0.01 s) and is associated with the cell information and the coordinate information.

When the pressing force is not applied to the touch panel 19, the electronic writing device 20 does not transmit the cell information and the coordinate information to the PC 10. When the cell information and the coordinate information are not transmitted from the electronic writing device 20 for a time period that is longer than the predetermined time T (no at step S1), the CPU 11 determines that the user of the electronic writing device 20 has completed a series of pressing operations on the touch panel 19. The series of pressing operations corresponds to one stroke of a writing operation on the electronic writing device 20. The one stroke of the writing operation is, for example, a writing operation of a row of characters or a writing operation of a single character. When the one stroke of the writing operation is performed, the cell information and the coordinate information indicating the pressed position based on the one stroke of the writing operation are stored in the table 141. When the cell information and the coordinate information corresponding to the one stroke of the writing operation are stored in the table 141, the CPU 11 extracts the coordinate information stored in the table 141 in sequence for each cell (step S5).

In the table 141 shown in FIG. 5, for example, the cell information (Cell_X, Cell_Y=3, 3) is stored in association with the time information 0. The coordinate information associated with the cell information that is the same as the cell information (Cell_X, Cell_Y=3, 3) is extracted. Specifically, in the table 141 shown in FIG. 5, the coordinate information associated with the time information 0, 0.01, 0.02 and so on is extracted. The CPU 11 further extracts, from among the extracted coordinate information, the coordinate information for which the associated time information is continuous. In other words, from among the extracted coordinate information, the coordinate information is extracted for which the time information is the interval of the predetermined time T. The extracted coordinate information is stored in the table 131 (refer to FIG. 7) of the RAM 13 along with the time information and the cell information. The coordinate information that is associated with the cell information (Cell_X, Cell_Y=3, 3) and for which the time information is continuous is stored in the table 131 shown in FIG. 7. Each piece of the coordinate information is associated with a number (1, 2 . . . N−1). Note that a method for extracting the coordinate information at step S5 can be changed. For example, the CPU 11 may extract the coordinate information that is associated with the same cell information irrespective of whether the time information is continuous, and may store the extracted coordinate information in the table 131.

The cell information that is to be extracted in the processing at step S5 is updated each time the processing at step S5 is repeatedly executed (no at step S7→step S5, to be explained later).

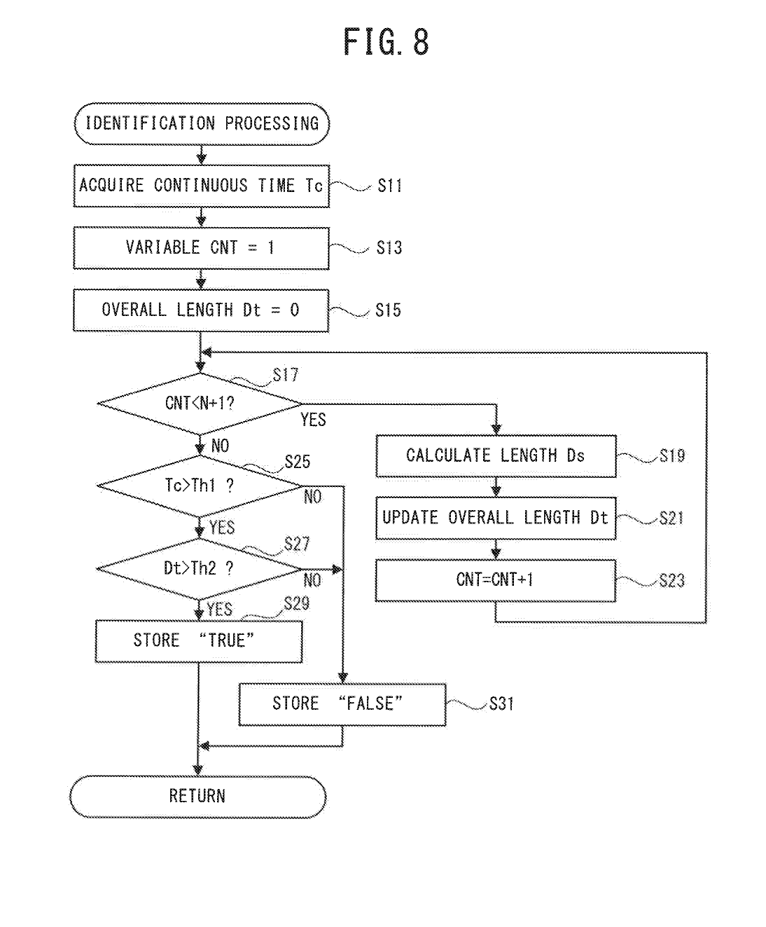

The CPU 11 executes identification processing (refer to FIG. 8) (step S6). Hereinafter, a first example of the identification processing executed by the CPU 11 will be explained with reference to FIG. 8. The identification processing is processing in which, based on the extracted coordinate information, the specified position specified by the writing operation using the writing tool 2 is distinguished from another pressed position and is identified. Hereinafter, the cell information (Cell_X, Cell_Y) that corresponds to a number n in the table 131 (refer to FIG. 7), which includes the coordinate information extracted at step S5 (refer to FIG. 6), is denoted by cell information (Cell_X (n), Cell_Y(n)). The coordinate information (X, Y) corresponding to the number n is denoted by coordinate information (X(n), Y(n)). Tc, CNT, Dt and Ds each indicate a variable used by the CPU 11 in the identification processing.

The CPU 11 acquires a continuous time Tc (step S11). The continuous time Tc indicates a time used to perform the one stroke of the writing operation. The continuous time Tc is calculated by subtracting, among times indicated by the time information stored in the table 141 (refer to FIG. 5), a minimum time from a maximum time. The maximum time is a maximum value among the pieces of time information stored in the table 141. The minimum time is a minimum value among the pieces of time information stored in the table 141. In other words, the continuous time Tc is a time period from when the pressing force is first applied in the state in which the pressing force is not applied to the touch panel 19, up to when the pressing force is no longer applied to the touch panel 19. In the table 141, the cell information and the coordinate information are stored that indicate the series of pressed positions from when the pressing force is first applied in the state in which the pressing force is not applied to the touch panel 19, up to when the pressing force is no longer applied to the touch panel 19. Specifically, the cell information and the coordinate information that indicate the pressed position based on the one stroke of the writing operation are stored in the table 141. Thus, the acquired continuous time Tc indicates the time used to perform the one stroke of the writing operation. When referring to the table 141 shown in FIG. 5, for example, a continuous time 1.54 s is calculated by subtracting a minimum time 0 s from a maximum time 1.54 s.

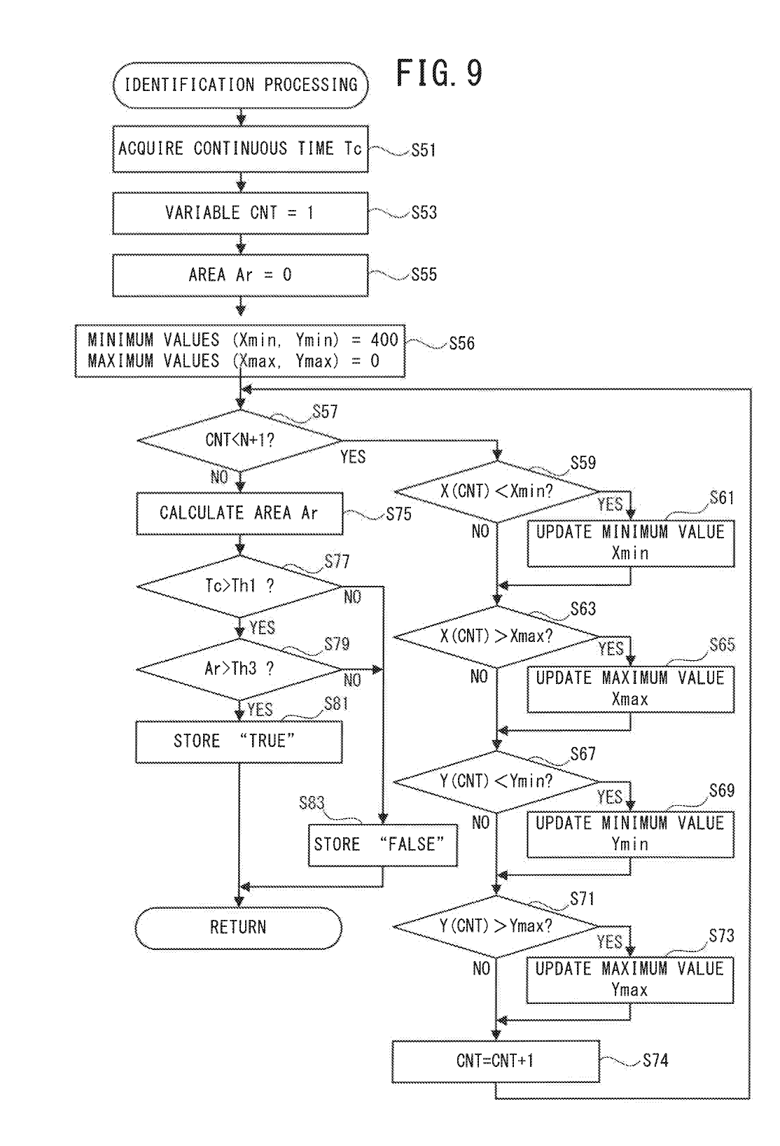

Note that a method of acquiring the continuous time Tc can be changed. For example, the CPU 11 may acquire, as the continuous time Tc, a value that is obtained by subtracting a minimum time from a maximum time among times indicated by the time information stored in the table 131 (refer to FIG. 7). This change can also be applied in second to fourth examples (refer to FIG. 9 to FIG. 11) that will be explained later.

The CPU 11 performs initialization by setting the variable CNT to 1 (step S13). The variable CNT is a variable that is used to identify the coordinate information. For example, when a value of the variable CNT is 1, the coordinate information associated with the number 0 in the table 131 is identified based on the variable CNT. The CPU 11 performs initialization by setting the overall length Dt to 0 (step S15). The overall length Dt indicates a length of one stroke. As shown in FIG. 7, a number of pieces of coordinate information stored in the table 131 is N. By comparing a value N+1 to the variable CNT, the CPU 11 determines whether the processing has been performed on all the coordinate information stored in the table 131 (step S17). When the variable CNT is smaller than N+1 (yes at step S17), this means that, among the coordinate information stored in the table 131, there is the coordinate information that has not been selected as a processing target.

When the value of the variable CNT is smaller than N+1 (yes at step S17), the CPU 11 calculates the length Ds of a line segment that joins two points indicated by two continuous pieces of the coordinate information (X(CNT−1), Y(CNT−1)), (X(CNT), Y(CNT)) (step S19). The length Ds is calculated based on the following formula.

Ds=√((X(CNT)−(X(CNT)−1))²+(Y(CNT)−Y(CNT−1)²)

By adding the calculated length Ds to the overall length Dt, the CPU 11 updates the overall length Dt (step S21). The CPU 11 updates the value of the variable CNT by adding 1 to the variable CNT (step S23). The processing returns to step S17.

Based on the updated variable CNT, the processing from step S17 to step S23 is repeated. When the variable CNT is equal to or larger than N+1 (no at step S17), this means that the processing from step S19 to step S23 has been performed on all the coordinate information stored in the table 131. Therefore, the overall length Dt corresponds to an accumulated value of a length of a line segment that joins, in sequence, a plurality of points identified by the coordinate information included in the table 131. The processing advances to step S25.

The CPU 11 determines whether the continuous time Tc acquired at step S11 is larger than a time threshold value Th1 that is a predetermined threshold value (step S25). Normally, a certain time is required to perform the one stroke of the writing operation. When the continuous time Tc is equal to or smaller than the time threshold value Th1 (no at step S25), the CPU 11 associates FALSE, as the noise classification, with the cell information stored in the table 141 that is the same as the cell information stored in the table 131 and stores the associated information (step S31). FALSE is information indicating that the pressed position is not the specified position. In this way, it is determined that the pressed cell identified by the cell information stored in the table 141 has not been specified by a pressing operation of the user. The identification processing ends and the processing returns to the main processing (refer to FIG. 6).

On the other hand, when the continuous time Tc acquired at step S11 is larger than the time threshold value Th1 (yes at step S25), the CPU 11 determines whether the overall length Dt calculated at step S21 is larger than a length threshold value Th2 that is a predetermined threshold value (step S27). When the overall length Dt is equal to or smaller than the length threshold value Th2 (no at step S27), the CPU 11 associates FALSE, as the noise classification, with the cell information in the table 141 that is the same as the cell information stored in the table 131 and stores the associated information (step S31). The identification processing ends and the processing returns to the main processing (refer to FIG. 6).

When the overall length Dt calculated at step S21 is larger than the length threshold value Th2 (yes at step S27), the CPU 11 associates TRUE, as the noise classification, with the cell information in the table 141 that is the same as the cell information stored in the table 131 and stores the associated information (step S29). TRUE is information indicating that the pressed position is the specified position. The identification processing ends and the processing returns to the main processing (refer to FIG. 6).

As shown in FIG. 6, after the identification processing (step S6) ends, the CPU 11 determines whether the processing that extracts the coordinate information for each cell at step S5 has been performed on all of the cells (step S7). In a case where there are cells remaining for which the coordinate information has not been extracted (no at step S7), the processing returns to step S5. The coordinate information is extracted for each of the remaining cells (step S5) and the identification processing (step S6) is repeated. In a case where the identification processing has been performed on all of the cells (yes at step S7), the processing returns to step S1.

Based on the table 141 created in the above-described manner, the CPU 11 can output a trajectory of the writing operation in the manner described below, for example. The CPU 11 calculates overall coordinate information based on the cell information and the coordinate information that are associated with the noise classification information TRUE which indicates, in the table 141, that the pressed position is the specified position. The overall coordinate information is coordinate information of the specified positions on the touch panel 19 as a whole. A reference position of the overall coordinate information is the lower left point of the touch panel 19. For example, of the coordinate information stored in the table 141, the CPU 11 adds up the coordinate information of the lower left points of the cells identified by the cell information corresponding to the coordinate information that is associated with the noise classification information TRUE, which indicates that the pressed position is the specified position.

The CPU 11 outputs, from the output portion 16, information indicating the positions indicated by the calculated overall coordinate information. For example, the CPU 11 outputs, to the output portion 16, dots that indicate the positions indicated by the overall coordinate information. In this way, an image is output to the output portion 16 in which a plurality of dots are arranged alongside each other. In this manner, by referring to the image output on the output portion 16, the user can verify the trajectory of the writing operation performed on the touch panel 19 by the user.

In the first example explained above, the CPU 11 joins, using line segments, the plurality of pressed positions indicated by the plurality of pieces of coordinate information. The CPU 11 identifies the accumulated value (the overall length Dt) of the lengths of those line segments as a change tendency in the pressed positions. When the overall length Dt is larger than the length threshold value Th2, it is determined that each of the pressed positions is the specified position. When the user draws a character or a graphic etc. on the touch panel 19 using the writing tool 2, there is a strong tendency for a movement distance of the specified positions to be long. When the overall length Dt is larger than the length threshold value Th2, this means that the pressed position has moved over a distance that is longer than the distance indicated by the length threshold value Th2. The specified position is identified based on the length threshold value Th2, and the CPU 11 can therefore appropriately identify the specified position. Further, when the continuous time Tc is larger than the length threshold value Th1, the CPU 11 determines that each of the pressed positions is the specified position. There are many cases in which a certain time is required in order to draw a character or a graphic etc. By determining the specified position based on the overall length Dt and the continuous time Tc, the CPU 11 can appropriately determine the specified position.

A second example of identification processing performed by the CPU 11 will be explained with reference to FIG. 9. Identification processing shown in FIG. 9 is called up from the main processing (refer to FIG. 6). Note that Tc, CNT, Ar, Xmin, Ymin, Xmax and Ymax each indicate a variable that is used in the identification processing by the CPU 11.

Based on the time information stored in the table 141 (refer to FIG. 5), the CPU 11 acquires the continuous time Tc (step S51). The CPU 11 performs initialization by setting the variable CNT to 1 (step S53). The CPU 11 performs initialization by setting an area Ar to 0 (step S55). In the present embodiment, an acquirable range over which values of the coordinate information (X, Y) can be acquired is (0, 0) to (400, 400). The CPU 11 performs initialization by setting minimum values (Xmin, Ymin) of the coordinate information to (400, 400) and maximum values (Xmax, Ymax) to (0, 0) (step S56). Specifically, at step S56, the CPU 11 sets, respectively, upper limits of the acquirable range as the minimum values (Xmin, Ymin) of the coordinate information. The CPU 11 sets, respectively, lower limits of the acquirable range as the maximum values (Xmax, Ymax) of the coordinate information.

The CPU 11 compares N+1 (obtained by adding 1 to the value N) and the variable CNT, and thus determines whether the processing has been performed on all of the coordinate information stored in the table 131 (refer to FIG. 7) (step S57). When the variable CNT is smaller than N+1 (yes at step S57), the CPU 11 extracts, from the table 131, the CNT-th coordinate information (X(CNT), Y(CNT)). The CPU 11 compares the extracted coordinate information X(CNT) with the minimum value Xmin (step S59). When the coordinate information X(CNT) is smaller than the minimum value Xmin (yes at step S59), the CPU 11 updates the minimum value Xmin by setting the coordinate information X(CNT) as the minimum value Xmin (step S61). The processing advances to step S63. When the minimum value Xmin is equal to or smaller than the coordinate information X(CNT) (no at step S59), the processing advances to step S63.

The CPU 11 compares the extracted coordinate information X(CNT) to the maximum value Xmax (step S63). When the coordinate information X(CNT) is larger than the maximum value Xmax (yes at step S63), the CPU 11 updates the maximum value Xmax by setting the coordinate information X(CNT) as the maximum value Xmax (step S65). The processing advances to step S67. When the maximum value Xmax is equal to or larger than the coordinate information X(CNT) (no at step S63), the processing advances to step S67.

The CPU 11 compares the extracted coordinate information Y(CNT) with the minimum value Ymin (step S67). When the coordinate information Y(CNT) is smaller than the minimum value Ymin (yes at step S67), the CPU 11 updates the minimum value Ymin by setting the coordinate information Y(CNT) as the minimum value Ymin (step S69). The processing advances to step S71. When the minimum value Ymin is equal to or smaller than the coordinate information Y(CNT) (no at step S67), the processing advances to step S71.

The CPU 11 compares the extracted coordinate information Y(CNT) to the maximum value Ymax (step S71). When the coordinate information Y(CNT) is larger than the maximum value Ymax (yes at step S71), the CPU 11 updates the maximum value Ymax by setting the coordinate information Y(CNT) as the maximum value Ymax (step S73). The processing advances to step S74. When the maximum value Ymax is equal to or larger than the coordinate information Y(CNT) (no at step S71), the processing advances to step S74. The CPU 11 adds 1 to the variable CNT and updates the variable CNT (step S74). The processing returns to step S57.

Based on the updated variable CNT, the processing from step S59 to step S74 is repeated. When the variable CNT is equal to or larger than N+1 (no at step S57), this means that the processing from step S59 to step S74 has been performed on all of the coordinate information stored in the table 131. The CPU 11 uses the minimum values (Xmin, Ymin) and the maximum values (Xmax, Ymax) to define a quadrangle having (Xmin, Ymin), (Xmax, Ymin), (Xmax, Ymax) and (Xmin, Ymax) as coordinates of vertices of the quadrangle. The defined quadrangle corresponds to a quadrangle that surrounds all of the pressed points indicated by the coordinate information included in the table 131. The CPU 11 calculates the area Ar of the quadrangle having (Xmin, Ymin), (Xmax, Ymin), (Xmax, Ymax) and (Xmin, Ymax) as the coordinates of its vertices, based on the following mathematical formula (step S75).

Ar=(Xmax−Xmin)×(Ymax−Ymin)

The CPU 11 determines whether the continuous time Tc acquired at step S51 is larger than the time threshold value Th1 (step S77). When the continuous time Tc is equal to or smaller than the time threshold value Th1 (no at step S77), the CPU 11 associates FALSE, as the noise classification, with the cell information stored in the table 141 that is the same as the cell information stored in the table 131 and stores the associated information (step S83). The identification processing ends and the processing returns to the main processing (refer to FIG. 6).

When the continuous time Tc acquired at step S51 is larger than the time threshold value Th1 (yes at step S77), the CPU 11 determines whether the area Ar calculated at step S75 is larger than an area threshold value Th3 that is a predetermined threshold value (step S79). When the area Ar is equal to or smaller than the area threshold value Th3 (no at step S79), the CPU 11 associates FALSE as the noise classification with the cell information in the table 141 that is the same as the cell information stored in the table 131, and stores the associated information (step S83). The identification processing ends and the processing returns to the main processing (refer to FIG. 6).

When the area Ar calculated at step S75 is larger than the area threshold value Th3 (yes at step S79), the CPU 11 associates TRUE as the noise classification with the cell information in the table 141 that is the same as the cell information stored in the table 131, and stores the associated information (step S81). The identification processing ends and the processing returns to the main processing (refer to FIG. 6).

In the second example as described above, the CPU 11 identifies, as a change tendency, the minimum quadrangle area Ar that includes the plurality of pressed positions. When the user uses the writing tool 2 to draw a character or a graphic etc. on the touch panel 19, there is a strong tendency for a movement range of the specified position to become large. When the area Ar is larger than the area threshold value Th3, this means that the pressed position is moving over a region that is larger than a region having an area indicated by the area threshold value Th3. When the area Ar is larger than the area threshold value Th3, it is determined that each of the pressed positions is the specified position. By determining the specified position based on the quadrangle area Ar that includes the plurality of pressed positions, the CPU 11 can appropriately determine the specified position.

In the second example, it is determined whether the pressed position is the specified position based on the area Ar. Thus, even if the touch panel 19 is pressed frequently within a small region by an object other than the input portion, the pressed position is not mistakenly identified as the specified position. As a result, the CPU 11 can even more appropriately determine the specified position.

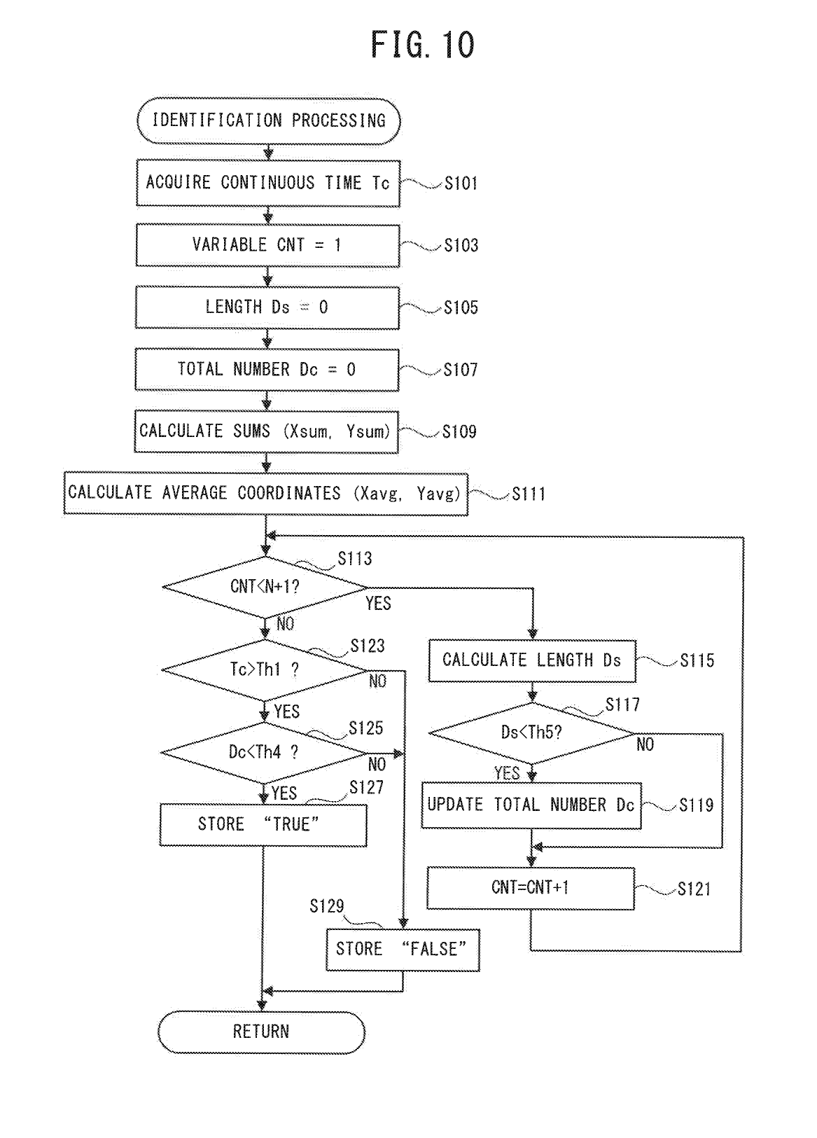

A third example of identification processing performed by the CPU 11 will be explained with reference to FIG. 10. Identification processing shown in FIG. 10 is called up from the main processing (refer to FIG. 6). Note that, Tc, CNT, Ds, Dc, Xsum, Ysum, Xavg and Yavg each indicate a variable that is used in the identification processing by the CPU 11.

Based on the time information stored in the table 141 (refer to FIG. 5) the CPU 11 acquires the continuous time Tc (step S101). The CPU 11 performs initialization by setting the variable CNT to 1 (step S103). The CPU 11 performs initialization by setting the length Ds to 0 (step S105). The CPU 11 performs initialization by setting the total number Dc to 0 (step S107).

Based on the coordinate information (X, Y) stored in the table 131 (refer to FIG. 6), the CPU 11 calculates a sum of the X coordinate values and a sum of the Y coordinate values (Xsum, Ysum), respectively. The CPU 11 calculates the sums (Xsum, Ysum) based on the following mathematical formulas (step S109).

Xsum=X(0)+X(1)+ . . . X(N−1)

Ysum=Y(0)+Y(1)+ . . . Y(N−1)

By dividing the calculated sums (Xsum, Ysum) by the value N, the CPU 11 calculates average coordinates (Xavg, Yavg) (step S111).

Xavg=Xsum/N

Yavg=Ysum/N

The CPU 11 compares N+1 (obtained by adding 1 to the value N) and the variable CNT, and thus determines whether the processing has been performed on all of the coordinate information stored in the table 131 (step S113). When the variable CNT is smaller than N+1 (yes at step S113), the CPU 11 extracts, from the table 131, the CNT-th coordinate information (X(CNT), Y(CNT)). The CPU 11 calculates, based on the following mathematical formula, the length Ds between a position indicated by the extracted coordinate information (X(CNT), Y(CNT)) and a position indicated by the average coordinates (Xavg, Yavg) calculated at step S111 (step S115).

Ds=√((X(CNT)−Xavg)²+(Y(CNT)−Yavg)²)

The CPU 11 determines whether the calculated length Ds is smaller than a distance threshold value Th5 that is a predetermined threshold value (step S117). In a case where the length Ds is smaller than the distance threshold value Th5 (yes at step S117), the CPU 11 updates the value of the total number Dc by adding 1 to the total number Dc (step S119). The processing advances to step S121. In a case where the length Ds is equal to or larger than the distance threshold value Th5 (no at step S117), the CPU 11 does not update the total number Dc and updates the value of the variable CNT by adding 1 to the variable CNT (step S121). The processing returns to step S113.

Based on the updated variable CNT, the processing from step S115 to step S121 is repeated. When the variable CNT is equal to or larger than N+1 (no at step S113), this means that the processing from step S115 to step S121 has been performed on all of the coordinate information stored in the table 131. The CPU 11 determines whether the continuous time Tc acquired at step S101 is larger than the time threshold value Th1 (step S123). When the continuous time Tc is equal to or smaller than the time threshold value Th1 (no at step S123), the CPU 11 associates FALSE, as the noise classification, with the cell information stored in the table 141 that is the same as the cell information stored in the table 131 and stores the associated information (step S129). The identification processing ends and the processing returns to the main processing (refer to FIG. 6).

When the continuous time Tc acquired at step S101 is larger than the time threshold value Th1 (yes at step S123), the CPU 11 determines whether the total number Dc calculated at step S119 is smaller than a predetermined number threshold value Th4 (step S125). When the total number Dc is equal to or larger than the number threshold value Th4 (no at step S125), the CPU 11 associates FALSE as the noise classification with the cell information in the table 141 that is the same as the cell information stored in the table 131, and stores the associated information (step S129). The identification processing ends and the processing returns to the main processing (refer to FIG. 6).

When the total number Dc calculated at step S119 is smaller than the number threshold value Th4 (yes at step S125), the CPU 11 associates TRUE as the noise classification with the cell information in the table 141 that is the same as the cell information stored in the table 131, and stores the associated information (step S127). The identification processing ends and the processing returns to the main processing (refer to FIG. 6).

In the third example as described above, the CPU 11 identifies, as a change tendency, a number (the total number Dc) of the pressed positions that are disposed within a distance indicated by the distance threshold value Th5 from the average position (average coordinates (Xavg, Yavg)) that indicates an average of the positions indicated by the coordinate information (X, Y). When the user uses the writing tool 2 to draw a character or a graphic etc. on the touch panel 19, as the movement range of the pressed positions becomes large, there is a strong tendency for the coordinates of the pressed position to be separated from the average coordinates. When the total number Dc is equal to or larger than the number threshold value Th4, this means that the pressed position has only moved with a region in the proximity of the average coordinates over a time period that is longer than the time threshold value Th1. When the total number Dc is smaller than the number threshold value Th4, this means that the pressed position has frequently moved to a region that is separated from the average coordinates. When the total number Dc is smaller than the number threshold value Th4, the CPU 11 determines each of the pressed positions as the specified position. Thus, the CPU 11 can appropriately determine the specified position based on the average position indicated by the average coordinates (Xavg, Yavg).

In the third example, it is determined whether the pressed position is the specified position based on the total number Dc. Therefore, for example, even if a certain pressed position is detected in a position that is significantly separated from another of the pressed positions due to an influence of momentary noise, the pressed position is not mistakenly identified as the specified position. As a result, the CPU 11 can even more appropriately determine the specified position.

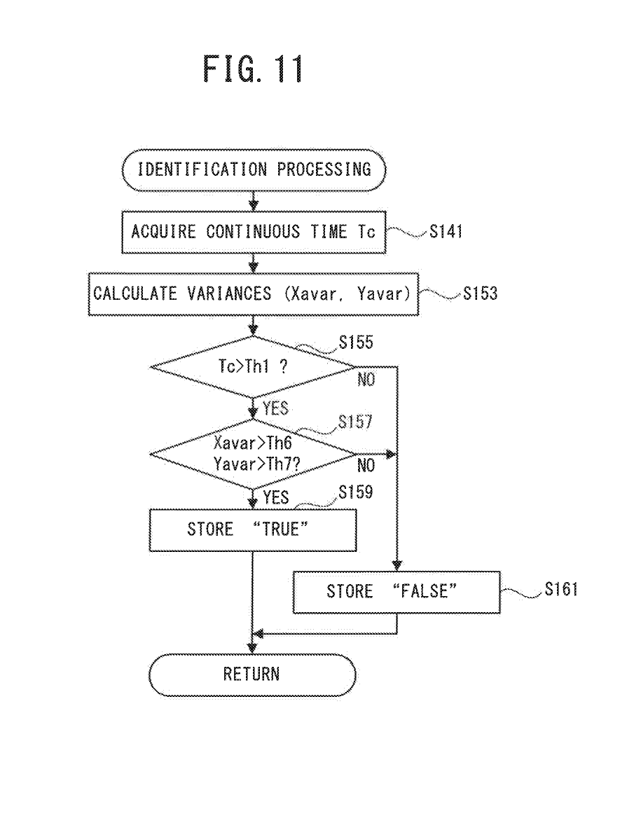

A fourth example of identification processing performed by the CPU 11 will be explained with reference to FIG. 11. Identification processing shown in FIG. 11 is called up from the main processing (refer to FIG. 6). Note that, Tc, Xavar and Yavar each indicate a variable that is used by the CPU 11 in the identification processing.

Based on the time information stored in the table 141 (refer to FIG. 5), the CPU 11 acquires the continuous time Tc (step S141). The CPU 11 calculates a variance Xavar and a variance Yavar based on a known calculation method (step S153). The variance Xavar is a variance in the X axis direction of the positions indicated by the coordinate information stored in the table 131. The variance Yavar is a variance in the Y axis direction of the positions indicated by the coordinate information stored in the table 131.

The CPU 11 determines whether the continuous time Tc acquired at step S141 is larger than the time threshold value Th1 (step S155). When the continuous time Tc is equal to or smaller than the time threshold value Th1 (no at step S155), the CPU 11 associates FALSE, as the noise classification, with the cell information stored in the table 141 that is the same as the cell information stored in the table 131 and stores the associated information (step S161). The identification processing ends and the processing returns to the main processing (refer to FIG. 6).

When the continuous time Tc acquired at step S141 is larger than the time threshold value Th1 (yes at step S155), the CPU 11 determines whether the variance Xavar calculated at step S153 is larger than a predetermined first variance threshold value Th6 and also whether the variance Yavar is larger than a predetermined second variance threshold value Th7 (step S157). When the variance Xavar is equal to or smaller than the first variance threshold value Th6, or when the variance Yavar is equal to or smaller than the second variance threshold value Th7 (no at step S157), the CPU 11 associates FALSE as the noise classification with the cell information in the table 141 that is the same as the cell information stored in the table 131, and stores the associated information (step S161). The identification processing ends and the processing returns to the main processing (refer to FIG. 6).

When the variance Xavar calculated at step S153 is larger than the first variance threshold value Th6 and the variance Yavar is larger than the second variance threshold value Th7 (yes at step S157), the CPU 11 associates TRUE as the noise classification with the cell information in the table 141 that is the same as the cell information stored in the table 131, and stores the associated information (step S159). The identification processing ends and the processing returns to the main processing (refer to FIG. 6).

In the fourth example as described above, the CPU 11 calculates the variances (Xavar, Yavar) in the X direction and the Y direction of the positions indicated by the coordinate information (X, Y), and identifies the calculated variances (Xavar, Yavar) as the change tendency. When the variances (Xavar, Yavar) are larger, respectively, than the first variance threshold value Th6 and the second variance threshold value Th7, each of the pressed positions is determined as the specified position. When the user uses the writing tool 2 to draw a character or a graphic etc. on the touch panel 19, the movement range of the pressed positions becomes large and thus there is a strong tendency for the variance to also become large. By determining the specified position based on the variances (Xavar, Yavar), the CPU 11 can appropriately determine the specified position.

In the fourth example, a degree of fluctuation in the pressed positions is identified by the variance, and it is determined whether the pressed position is the specified position based on the identified degree of fluctuation. As a result, it is possible to more appropriately determine whether the movement range of the pressed positions is large. The CPU 11 can thus even more appropriately determine the specified position.

Note that the present disclosure is not limited to the above-described embodiment, and various modifications are possible. In the above explanation, the writing operation on the touch panel 19 is performed using the writing tool 2. However, the writing operation on the touch panel 19 may be performed using an object other than the writing tool 2. For example, the writing operation may be performed using a finger (an index finger, for example).

Even if an operation (a multi-touch operation) in which a plurality of positions are simultaneously specified on the touch panel 19 is performed, the present disclosure can individually identify the cell information and the coordinate information of each specified position. As a result, by performing similar processing to that described above, it is possible to appropriately determine each of the specified positions.

The present disclosure can also be applied to a system that uses a touch panel having a known resistive film method that has only one orthogonal electrode. The present disclosure can also be applied to another type of touch panel, such as a matrix switching touch panel, a surface acoustic wave touch panel, an infrared touch panel, an electromagnetic induction touch panel or an electrostatic capacitive touch panel etc.

In the above-described embodiment, the PC 10 receives the cell information and the coordinate information from the electronic writing device 20, and the CPU 11 identifies the specified position by analyzing the cell information and the coordinate information. In the present disclosure, the CPU 21 of the electronic writing device 20, for example, may perform processing to eliminate an influence of noise and identify the specified position.

In the fourth example described above, the variance of the pressed positions is calculated as the tendency in the distribution of the pressed positions. A value that is calculated as the tendency in the distribution of the pressed positions may be calculated by another method of statistical analysis. For example, a standard deviation of the pressed positions may be calculated.

In the above-described embodiment, the CPU 11 extracts, from the table 141, the coordinate information having the same cell information for each cell. Based on the extracted coordinate information, the CPU 11 calculates one of the total length Dt (first example), the area Ar (second example), the total number Dc (third example) and the variances (Xavar, Yavar) (fourth example) and determines the specified position. However, the CPU 11 may simultaneously extract from the table 141 the coordinate information corresponding to two or more pieces of the cell information and store the extracted coordinate information in the table 131, and may perform the identification processing using the table 131.

A specific example will be explained. For example, when one of the identification processing shown in FIG. 9, FIG. 10 or FIG. 11 is called up from the main processing (refer to FIG. 6) and executed, at step S5 of the main processing (refer to FIG. 6), the CPU 11 simultaneously extracts from the table 141 the coordinate information corresponding to the two or more pieces of cell information and stores the extracted coordinate information in the table 131 (refer to FIG. 7) (step S5). The two or more cells are selected in the following manner. The CPU 11 selects one cell on the touch panel 19. Next, the CPU 11 selects a total of eight cells that surround the selected cell. The CPU 11 extracts, from the table 141, coordinate information corresponding to cell information for the selected total of nine cells. The CPU 11 associates the cell information indicating the selected total of nine cells with the extracted coordinate information, and stores the associated cell information and coordinate information in the table 131. Based on the table 131 storing the coordinate information, the identification processing (step S6 (refer to FIG. 9, FIG. 10 and FIG. 11)) is performed. In the identification processing, the specified position is determined while targeting the coordinate information corresponding to the cell information of the nine cells. The identification processing at step S5 is repeated (no at step S7→step S5) until all of the cells on the touch panel 19 have been selected.

By executing the above-described processing, the CPU 11 can determine the specified position based on the coordinate information of a plurality of the cells. The CPU 11 can therefore distinguish the specified position from another pressed position even when the specified position moves over a plurality of the cells, and the specified position can be even more reliably determined.

Further, in the above-described embodiment, the continuous time Tc is acquired based on the time information stored in the table 141. However, as already explained, the continuous time Tc may be acquired based on the time information stored in the table 131.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A panel control device comprising:
a processor configured to perform processes comprising:
acquiring a plurality of pressed positions, each of the plurality of pressed positions being a pressed position identified at each of a plurality of timings within a continuous time period, the continuous time period being a time period determined based on an operation time period in which a panel surface is pressed, and the pressed position being a position at which a pressing force is applied to the panel surface;
identifying a tendency of change of the pressed positions based on the plurality of pressed positions; and
determining each of the plurality of pressed positions as a specified position in a case where the identified tendency of change satisfies a predetermined condition, the specified position being a pressed position, on the panel surface, that is specified by a user.

2. The panel control device according to claim 1, wherein
the identifying includes, as the tendency of change, identifying a total length that is a sum of lengths of line segments joining the plurality of pressed positions in a sequence in which the plurality of pressed positions are pressed, and
the determining includes determining each of the plurality of pressed positions as the specified position in a case where the identified total length is larger than a length threshold value that is a predetermined threshold value.

3. The panel control device according to claim 1, wherein
the identifying includes, as the tendency of change, identifying an area of a region that includes the plurality of pressed positions, and
the determining includes determining each of the plurality of pressed positions as the specified position in a case where the identified area is larger than an area threshold value that is a predetermined threshold value.

4. The panel control device according to claim 1, wherein
the identifying includes, as the tendency of change, identifying a number of pressed positions, from among the plurality of pressed positions, that are each disposed in a position whose distance from an average position is smaller than a distance threshold value that is a predetermined threshold value, the average position being a position obtained by averaging the plurality of pressed positions, and
the determining includes determining each of the plurality of pressed positions as the specified position in a case where identified the number of pressed positions is smaller than a number threshold value that is a predetermined threshold value.

5. The panel control device according to claim 1, wherein
the identifying includes, as the tendency of change, identifying a distribution tendency of the plurality of pressed positions, and
the determining includes determining each of the plurality of pressed positions as the specified position in a case where the identified distribution tendency satisfies the predetermined condition.

6. The panel control device according to claim 5, wherein
the identifying includes identifying a first variance of the plurality of pressed positions and a second variance of the plurality of pressed positions, the first variance being a variance of the plurality of pressed positions in a first direction, the second variance being a variance of the plurality of pressed positions in a second direction, and the second direction being a direction that is orthogonal to the first direction, and
the determining includes determining each of the plurality of pressed positions as the specified position in a case where the identified first variance is larger than a first variance threshold value that is a predetermined threshold value and the identified second variance is larger than a second variance threshold value that is a predetermined threshold value.

7. The panel control device according to claim 1, wherein
the determining includes determining each of the plurality of pressed positions as the specified position in a case where the tendency of change satisfies the predetermined condition and the continuous time period is larger than a time threshold value that is a predetermined threshold value.

8. The panel control device according to claim 1, wherein
the acquiring includes acquiring the plurality of pressed positions for each of a plurality of cells, the plurality of cells being a plurality of regions into which the panel surface is divided, and
the identifying includes identifying the tendency of change for each of the plurality of cells.

9. The panel control device according to claim 1, wherein
the continuous time period is a time period from when a pressing force is applied to the panel surface in a state in which a pressing force is not being applied to the panel surface to when the pressing force is no longer applied.

10. A panel control method comprising:
acquiring a plurality of pressed positions, each of the plurality of pressed positions being a pressed position identified at each of a plurality of timings within a continuous time period, the continuous time period being a time period determined based on an operation time period in which a panel surface is pressed, and the pressed position being a position at which a pressing force is applied to the panel surface;
identifying, based on the acquired plurality of pressed positions, a tendency of change of the pressed positions; and
determining each of the plurality of pressed positions as a specified position in a case where the identified tendency of change satisfies a predetermined condition, the specified position being a pressed position, on the panel surface, that is specified by a user.

11. A non-transitory computer-readable medium storing computer-readable instructions that cause a panel control device to perform the steps of:
acquiring a plurality of pressed positions, each of the plurality of pressed positions being a pressed position identified at each of a plurality of timings within a continuous time period, the continuous time period being a time period determined based on an operation time period in which a panel surface is pressed, and the pressed position being a position at which a pressing force is applied to the panel surface;
identifying, based on the acquired plurality of pressed positions, a tendency of change of the pressed positions; and
determining each of the plurality of pressed positions as a specified position in a case where the identified tendency of change satisfies a predetermined condition, the specified position being a pressed position, on the panel surface, that is specified by a user.
